(19) United States
(12) Patent Application Publication
(10) Pub. No.: US 2018/0204163 A1
(43) Pub. Date: Jul. 19, 2018

(54) OPTIMIZING HUMAN AND NON-HUMAN RESOURCES IN RETAIL ENVIRONMENTS

(71) Applicant: International Business Machines Corporation, Armonk, NY (US)

(72) Inventors: Michael Bender, Rye Brook, NY (US); Rhonda L. Childress, Austin, TX (US); Donald L. Muchmore, Superior, CO (US)

(21) Appl. No.: 15/408,962

(22) Filed: Jan. 18, 2017

(51) Int. Cl. G06Q 10/06; G06Q 30/02

(52) U.S. Cl. CPC G06Q 10/06315; G06Q 30/0201

(57) ABSTRACT

A method and system for managing resources in a retail environment, including: (i) providing a retail environment system comprising a processor and a plurality of sensors, and further comprising at least one human resource and/or at least one automated resource, wherein the retail environment is associated with at least one retail objective; (ii) receiving sensor data representing information about at least one consumer in the retail environment; (iii) identifying, using the received sensor data, a resource event comprising an event for which the at least one human resource or the at least one automated resource may be utilized; (iv) assigning, by the processor, a priority to the identified resource event based at least in part on the at least one retail objective; and (v) managing at least one of the at least one human resources or the at least one automated resources based on the assigned priority.

### BACKGROUND

The present invention is directed to methods and systems for optimizing a retail environment by sensing and analyzing customer needs and deploying human and/or automated resources in response to those needs.

Brick and mortar retail environments are designed to maximize customer engagement. Retail store design has changed how these physical spaces are structured in order to increase consumer throughput while maximizing sales and profitability. As a result, consumer behavior has been widely studied in order to extract common behavior patterns that can be utilized to improve store design.

In recent years, the availability, decreased size, and affordability of sensor technology has resulted in consumer behavior being analyzed in real-time. Among other things, cameras detect high-traffic areas, detect activity around specific areas within the store, estimate customer density, and more. Other sensors working separately from or together with cameras similarly track and analyze consumer behaviors. This information is then utilized to increase consumer throughput while maximizing sales.

Current systems for analyzing and responding to consumer behavior are inefficient and typically do not produce sufficiently positive outcomes. For example, these existing systems typically do not analyze and respond to consumer behavior in real-time, which is an essential requirement for maximizing consumer interactions. Instead, existing systems use this information to make changes in the future rather than automatically redistributing existing resources. Existing systems also fail to consider non-human resources when responding to consumer behaviors in real-time. Similarly, existing systems often fail to incorporate consumer history or other associated information into the analysis and subsequent response. As a result, many of the customer actions occurring in the brick and mortar setting that could be converted to a sale or increased sales are not capitalized on as a result of poorly distributed or allocated resources.

Accordingly, there is a continued need in the art for systems and methods that analyze consumer behavior in real-time and automatically utilize that information to redistribute human and non-human resources to take advantage of that consumer behavior.

### SUMMARY

The disclosure is directed to inventive methods and systems that utilize sensor data and consumer history to manage human and non-human resources while cognizant of the profitability of items being considered by consumers, the loyalty of the consumers, and the standard or standards that the retail environment has set, in order to optimize consumer satisfaction, increase consumer throughput, and maximize sales. Under the present invention, a system is enabled to utilize historical sensor data, historical information, consumer profiles, and a resource management system in order to allocate resources to achieve one or more predetermined retail goals of the retail environment. This information, together with the real-time sensor data, is considered by a trade-off engine that can suggest or automatically deploy resources based on the configuration of the system and the goals of the retail setting.

According to an aspect is a method for managing resources in a retail environment. The method includes the steps of: (i) providing a retail environment system comprising a processor and a plurality of sensors in communication with the processor, and further comprising at least one human resource and/or at least one automated resource, wherein the retail environment is associated with at least one retail objective; (ii) receiving, from at least one of the plurality of sensors, sensor data representing information about at least one consumer in the retail environment; (iii) identifying, by the processor using the received sensor data, a resource event comprising an event for which the at least one human resource or the at least one automated resource may be utilized; (iv) assigning, by the processor, a priority to the identified resource event based at least in part on the at least one retail objective; and (v) managing at least one of the at least one human resource or the at least one automated resource based on the assigned priority.

According to an embodiment, the resource event comprises a location of the at least one consumer.

According to an embodiment, the resource event comprises an activity of the at least one consumer.

According to an embodiment, the retail objective comprises maximizing consumer satisfaction, maximizing profitability, and/or maximizing consumer spending.

According to an embodiment, the priority is assigned based at least in part on a weighting system. According to an embodiment, the weighting system comprises a plurality of weighting factors. According to an embodiment, the weighting factors comprise historical information about the at least one consumer, an identity of a retail item within the retail environment being purchased by the consumer, at least one known preference of the consumer, or a profit margin of a retail item within the retail environment.

According to an embodiment, the sensor data represents information about at least retail item within the retail environment.

According to an embodiment, the at least one human resource comprises an employee of the retail environment, and the at least one automated resource comprises a machine within the retail environment.

According to an embodiment, the method further includes the step of analyzing a status of the at least one human resource and/or the at least one automated resource within the retail environment, and further wherein said managing step is also based at least in part on the analyzed status.

According to as aspect is a computer system configured to manage resources in a retail environment. The system includes a retail environment comprising a plurality of sensors, at least one human resource, and/or at least one automated resource, wherein the retail environment is associated with at least one retail objective; and a processor configured to: (i) receive, from at least one of the plurality of sensors, sensor data representing information about at least one consumer in the retail environment; (ii) identify, by the processor using the received sensor data, a resource event comprising an event for which the at least one human resource or the at least one automated resource may be utilized; (iii) assign, by the processor, a priority to the identified resource event based at least in part on the at least one retail objective; and (iv) manage at least one of the at least one human resource or the at least one automated resource based on the assigned priority.

According to as aspect is a computer program product for managing resources in a retail environment. The computer program product is a computer readable storage medium having program instructions embodied therewith, wherein the computer readable storage medium is not a transitory signal per se. The program instructions are readable by a computer to cause the computer to perform a method comprising the steps of: (i) receiving, from at least one of a plurality of sensors within the retail environment, sensor data representing information about at least one consumer in the retail environment; (ii) identifying, by a processor using the received sensor data, a resource event comprising an event for which at least one human resource or at least one automated resource within the retail environment may be utilized; (iii) assigning, by the processor, a priority to the identified resource event based at least in part on at least one retail objective associated with the retail environment; and (iv) managing at least one of the at least one human resource or the at least one automated resource based on the assigned priority.

According to an aspect is a method for managing resources in a retail environment. The method includes the steps of: (i) receiving, from at least one of a plurality of sensors within the retail environment, sensor data representing information about at least one consumer in the retail environment; (ii) identifying, by a processor using the received sensor data, a resource event comprising an event for which at least one human resource or at least one automated resource within the retail environment may be utilized; (iii) assigning, by the processor, a priority to the identified resource event based at least in part on achieving at least one retail objective of the retail environment, wherein said priority is assigned using a weighting system comprising a plurality of weighting factors; and (iv) managing at least one of the at least one human resource or the at least one automated resource based on the assigned priority.

According to an aspect is a method for managing resources in a retail environment. The method includes the steps of: (i) receiving, from at least one of a plurality of sensors within the retail environment, sensor data representing information about at least one consumer in the retail environment; (ii) identifying, by a processor using the received sensor data, a resource event comprising an event for which at least one human resource or at least one automated resource within the retail environment may be utilized; (iii) assigning, by the processor, a priority to the identified resource event based at least in part on achieving at least one retail objective of the retail environment, wherein said priority is assigned using a weighting system comprising a plurality of weighting factors; (iv) generating, by the processor based at least in part on the assigned priority, a resource recommendation comprising a recommended allocation of at least one of the at least one human resource or the at least one automated resource; and (v) communicating the generated recommendation to a user.

These and other aspects of the invention will be apparent from the embodiments described below.

### BRIEF DESCRIPTION OF THE DRAWINGS

In the drawings, like reference characters generally refer to the same parts throughout the different views. Also, the drawings are not necessarily to scale, emphasis instead generally being placed upon illustrating the principles of the invention.

FIG. 1 is a schematic representation of a system for managing human and non-human resources within a retail environment, in accordance with an embodiment.

FIG. 2 is a flow chart of a method for managing human and non-human resources within a retail environment, in accordance with an embodiment.

FIG. 3 is a schematic representation of a system for managing human and non-human resources within a retail environment, in accordance with an embodiment.

### DETAILED DESCRIPTION

The present disclosure is directed to embodiments of a method and system for optimizing a retail environment by sensing and analyzing customer needs and deploying human and/or automated resources in response to those needs. According to an embodiment, the method and system optimizes resources in a retail setting where the resources are human or robotic, and where trade-offs are made when allocating the resources based on one or more goals of the retail environment, including but not limited to increasing consumer satisfaction and profitability. The system utilizes sensors such as motion detectors and cameras to identify consumers and the products with which they interact, and then assigns human and/or non-human resources to improve the customer experience or to achieve one or more other goals of the retail environment. All the collected information can be analyzed via a cognitive analysis to assign weighted measurements to optimize the customer experience, the checkout process, the utilization rate of staff, and profitability, among other goals.

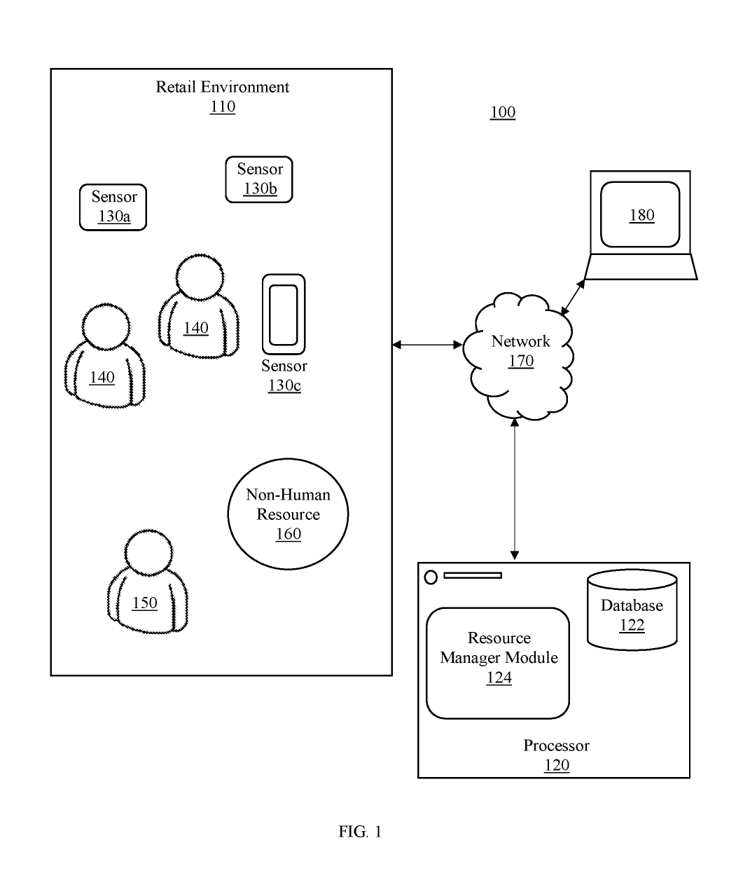

Referring to FIG. 1, in one embodiment, is a system 100 for allocating resources within a retail environment. According to an embodiment, system 100 comprises a retail environment 110 and a data processing environment comprising a processor 120 configured to determine and analyze consumer needs within the retail environment in order to deploy human and/or automated resources in response to those needs.

According to an embodiment, retail environment 110 is any environment in which one or more consumers 140 can be found, and/or any environment in which items, services, information, and/or other commodities are made available, offered for sale, or sold. For example, retail environment 110 may be any physical store or space where items are distributed or sold to one or more consumers. Among many other possibilities, retail environment 110 may be a grocery store, pharmacy, restaurant, gas station, department store, specialty store, music store, bookstore, office, or any other physical space. According to another embodiment, retail environment 110 is a manned or automated kiosk, a smartphone interaction, an online environment, a virtual environment, or any other retail environment. According to another embodiment, the retail environment comprises two or more environments such as two physical buildings, spaces, or environments, two online or virtual spaces or environments, and/or a combination of physical environments and online or virtual environments.

According to an embodiment, retail environment 110 comprises one or more sensors 130 located at one or more locations within the retail environment. The one or more sensors 130 are configured to obtain sensor data about, for example, the location and/or identity of one or more consumers 140 within retail environment 110. Sensor 130 may be, for example, a camera, an infrared sensor, an RFID reader, or any of a variety of other sensors. Sensor 130 may also be, for example, a sensor, chip, or device carried by consumer 140, such as a smartphone, RFID chip, or other passive or active device that may either transmit its location or have its location read by a corresponding reader.

Sensor 130 may be configured to obtain sensor data regarding, for example, the location of one or more items within retail environment 110, including but not limited to the items for distribution or sale within the retail environment. For example, the sensor may be an RFID reader, a camera, a QR code reader, a weight sensor located on a shelf on in a user's cart, or a variety of other sensors configured or capable of identifying, locating, and/or tracking one or more of the items for distribution or sale within the retail environment. For example, the items may comprise a WSN chip or other active or passive device that may transmit its location or otherwise have its location read by a corresponding reader. Items may further store information, and/or a centralized database may store information about each item. This information can include, for example, weight, overall cost, profitability, complexity, and much more.

The one or more sensors 130 are configured to obtain sensor data either periodically or continuously, and are further configured to transmit that information to processor 120 via a wired and/or wireless communications link. For example, system 100 may comprise a wired or wireless network 170, which can be, for example, the Internet, a LAN, Internet, cellular network, or any of a variety of other networks. The processor can then process the sensor data according to the methods described or otherwise envisioned herein.

Retail environment 110 can also comprise one or more human resources 150 located at one or more locations within the retail environment. The one or more human resources 150 provide assistance with the functioning of the retail environment, including but not limited facilitating consumer purchases. The one or more human resources 150 may be, for example, any individual providing services or information within the retail environment. For example, the human resource may be a retail worker, a sales clerk, a pharmacist, an assistant, a manager, an executive, a stock clerk, an information specialist, or any of a wide variety of other human resources located within retail environments.

Retail environment 110 can also comprise one or more non-human resources 160 located at one or more locations within the retail environment. The one or more non-human resources 160 are configured to provide assistance with the functioning of the retail environment, including but not limited facilitating consumer purchases. The one or more non-human resources 160 may be, for example, any resource providing services or information within the retail environment. For example, the one or more non-human resources 160 may be an automated checkout lane, an automated customer service computer or agent, or any of a wide variety of other non-human resources located within retail environments.

Processor 120 receives sensor data from the one or more sensors 130 of the retail environment 110 and processes that information to achieve one or more retail goals of the system. According to an embodiment, processor 120 comprises a general purpose processor, an application specific processor, or any other processor suitable for receiving sensor data and carrying out the processing steps as described or otherwise envisioned herein. According to an embodiment, processor 120 may be a combination of two or more processors.

According to an embodiment, processor 120 may be local or remote from retail environment 110. For example, processor 120 may be located within the retail environment, such as within a store or office. Processor 120 may also be located at a central location that services multiple retail environments. According to another embodiment, processor 120 is offered via a software as a service. One of ordinary skill will appreciate that non-transitory storage medium may be implemented as multiple different storage mediums, which may all be local, may be remote (e.g., in the cloud), or some combination of the two.

According to an embodiment, processor 120 comprises or is in communication with a non-transitory storage medium 122. Database 122 may be any storage medium suitable for storing program code for executed by processor 120 to carry out any one of the steps described or otherwise envisioned herein. Non-transitory storage medium may be comprised of primary memory, secondary memory, and/or a combination thereof. As described in greater detail herein, database 122 may comprise one or more user profiles, item information, and current retail environment resources.

According to an embodiment, processor 120 comprises a resource manager algorithm or module 124. Resource manager algorithm or module 124 may be configured to comprise, perform, or otherwise execute any of the functionality described or otherwise envisioned herein. According to an embodiment, resource manager algorithm or module 124 receives sensor data and utilizes that sensor data to identify a resource event and determine which of the retail environment's human and/or non-human resources to allocate in order to advance one or more retail goals of the retail environment.

According to an embodiment, processor 120 receives data from one or more sensors 130 comprising information about one of the consumers 140 in the retail environment 110. Processor 120 utilizes the sensor data to identify a resource event, which is any occurrence for which the resources of the store may be used to advance an objective of the store. For example, one resource event could be that a customer is browsing expensive and complex merchandise, requiring the expertise of a human or robotic staff-member to help the customer select the correct product. Once processor 120 identifies the resource event, the processor may prioritize the resource event with respect to other resource events in the store and the store resources available. Prioritizing the event may involve assigning a set of weights to the resource event according to the desired objectives of the store. By comparing the weighting of the resource event against the available store resources, processor 120 manages the store resources to best achieve one or more of the desired retail objectives or goals of retail environment 110.

According to an embodiment, one or more system users, such as the owners or organizers of the retail environment, utilize a computer 180 or other user interface to access the system, and thus a wired or wireless communication network 170 can exist between the user's computer 180 and the system. The wired or wireless communication network 170 can be, for example, the Internet, a LAN, Internet, cellular network, or any of a variety of other networks.

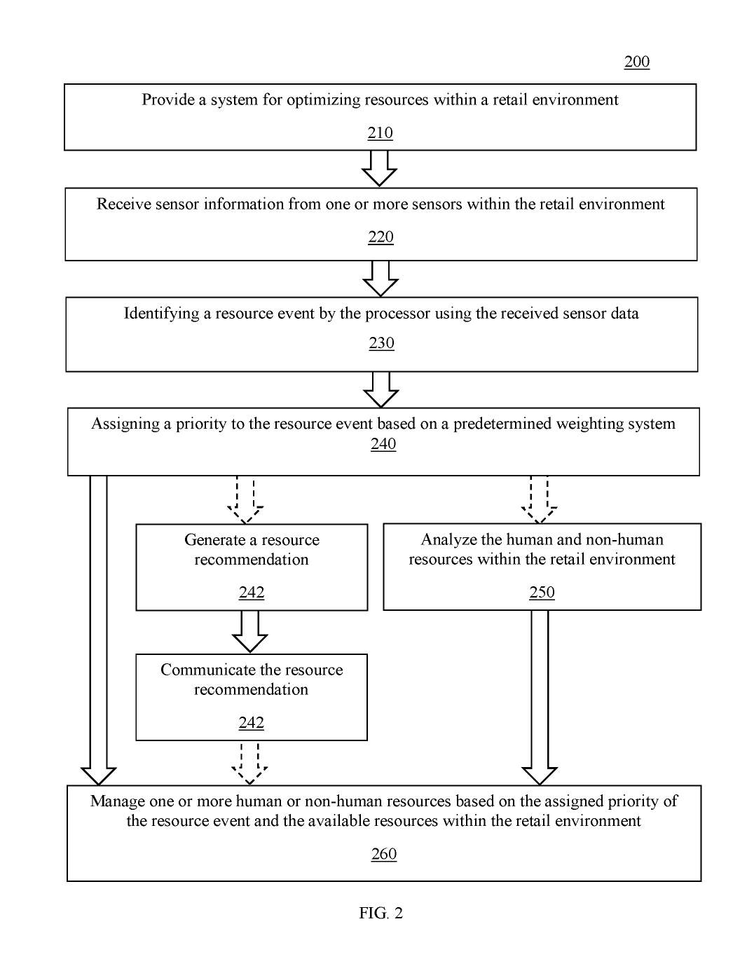

Referring to FIG. 2, in one embodiment, is a flowchart of a method 200 for optimizing resources in a retail environment by sensing and analyzing customer needs and deploying human and/or automated resources in response to those needs. According to an embodiment, at step 210 of the method, a system 100 is provided. System 100 can comprise any of the components described or otherwise envisioned herein, including but not limited to the data processing environment comprising a processor 120, database 122, and resource manager algorithm or module 124.

At step 220 of the method, system 100 receives sensor data from the one or more sensors 130 located at one or more locations within the retail environment. The one or more sensors 130 are configured to obtain sensor data about, for example, the location and/or identity of one or more consumers 140 within retail environment 110. The sensor data may be obtained or received periodically and/or continuously. The sensor data utilized by the system may be obtained in real-time, and/or may be stored historical sensor data. The sensor data is automatically communicated to, or is requested by and sent to, the processor 120.

At step 230 of the method, a resource event is identified by the processor using the received sensor data. A resource event is any occurrence for which one or more of the human and/or non-human resources of the retail environment may be utilized. The processor may be configured to identify a variety of predetermined triggers, events, or other occurrences that represent a resource event. According to an embodiment, a resource event may be identified by tracking the flow of customers or an individual customer, a customer interacting with one or more products, a customer approaching checkout, or a myriad of other possible occurrences. One of ordinary skill in the art will appreciate—in conjunction with a review of this disclosure—that identifying a resource event may be achieved in any number of ways. Further, each resource event may be identified in several different ways.

According to an embodiment, one example of the identification of a resource event is when a consumer picks an item off a shelf and looks at it for a predetermined length of time (e.g., three minutes). This may signify to the processor that the consumer could use additional information about the selected product. Accordingly, the processor identifies this consumer action as a resource event.

According to an embodiment, one example of the identification of a resource event is when a consumer enters a location in store near expensive or complex items. This may signify to the processor that the consumer requires help from a staff member select the correct item to meet the consumer's needs. Accordingly, the processor identifies this consumer action as a resource event.

According to another embodiment, one example of the identification of a resource event is when a consumer is browsing within a given department or location but does not select any items for purchase during a given period of time. This may signify to the processor that a human resource, such as a staff member, should be deployed to help the consumer select the right item. Accordingly, the processor identifies this consumer action as a resource event.

According to another embodiment, one example of the identification of a resource event is when a consumer approaches or is standing with a checkout line or lane. Depending on the availability of checkout lanes, this may signify to the processor that additional checkout lanes must be opened to efficiently service the consumer. Accordingly, the processor identifies this consumer action as a resource event.

According to another embodiment, one example of the identification of a resource event is when a consumer cart includes several heavy items and enters a checkout lane. This may signify to the processor that the consumer will require help unloading the consumer's cart. Accordingly, the processor identifies this consumer action as a resource event.

According to another embodiment, one example of the identification of a resource event is when a consumer places an item back on a shelf. This may signify to the processor that the consumer does not need a checkout, and fewer resources may be allocated to keeping checkout lanes open. Accordingly, the processor identifies this consumer action as a resource event.

According to another embodiment, one example of the identification of a resource event is when a consumer places an item on an incorrect shelf. This may signify to the processor that a staff member must be deployed to relocate the item to the correct shelf. Accordingly, the processor identifies this consumer action as a resource event.

Each of these examples represents a point that retail environment resources (e.g., staff members, traditional or self-service checkout registers, etc.) may be deployed to advance the particular objectives of the store, such as, for example, profitability, efficiency, user satisfaction, or a combination of those. Many other examples and implementations are possible.

At step 240 of the method, a priority is assigned to the resource event based on a predetermined weighting system, which may comprise one or more weighting factors. These factors may in turn be selected or weighted according to a set of predetermined retail objectives or goals of the retail environment in order to calculate the priority of the resource event.

One of these weighting factors may comprise, for example, a consumer's loyalty and/or historic profitability. For example, a resource event associated with consumer having a historic loyalty (e.g., according to total number of purchases, frequency of purchases, duration of patronage, or some combination of these or other factors) or profitability (e.g., total profitable over course of store patronage, profitability per visit, or some combination of these or factors), may receive a higher weight than a resource events associated with a consumer having lower historic loyalty or profitability.

One of these weighting factors may comprise, for example, a consumer's known or ascertained preferences. For example, a consumer may configure a consumer profile in advance, listing the consumer's preference for service, such as whether the consumer prefers help from staff, whether the consumer prefers human or robotic staff interaction, and so on. For example, the consumer may evidence a preference for a human resource or for an automated resource in a previous interaction with the system. This can then be input into the system when deciding what resource is assigned or otherwise modified. Alternatively, the consumer's profile may be configured automatically or may be entered by staff according to observations made over the course of the consumer's patronage. For example, if a consumer repeatedly declines help from human or robotic staff, the system may automatically note that consumer prefers to shop with help from one or the other. This note may alternately, be made by a member of the staff.

One of these weighting factors may comprise the profit margin or other value of an item viewed by the consumer, or the profit margin and/other value of the kinds of items the consumer has historically purchased. For example, if a consumer handles a high-profit item, the associated resource event may receive a higher weight than it would if the consumer holds a low-profit item. Similarly, if a consumer is spending time in an area of a retail environment filled with high-profit items—such as electronics or appliances—the associated resource event may receive a greater weight than if the consumer were in an area with low-profit items.

According to an embodiment, a weighting factor may be added, removed, or modified based on the identity of the item being considered or being purchased by the consumer. For example, the system may assign a weighting factor for an item placed by the consumer in the cart, bin, carrier, or directly carried by the consumer. That weighting factor may be based on the identity of the item or any other parameter or consideration disclosed or otherwise envisioned herein. When the consumer adds a second item, the weight factor may then be modified or removed, and/or a new weighting factor may be applied. Additional items may further change the one or more weighting factors.

The one or more factors that are considered in the weighting process, and/or the weights that are applied to those factors, may be predetermined and fixed within the system or algorithm. Alternatively, the factors and/or the weights applied to those factors may be variable, including but not limited to changing these factors and weights over time by the algorithm, by a user, by an organization, and so on.

According to an embodiment, the factors considered and/or the weight assigned to each factor is selected according to the retail environment's retail goals, which may be predetermined by a user. For example, if a retail environment emphasizes profitability over efficiency, the profit margin of a selected item or the consumer's historic spending may be given greater weight than other factors such as the duration of the consumer's patronage.

According to an embodiment, the retail goals or objectives of the retail environment may change over time. For example, if a store is going through a low-profit period, factors associated with profitability may be given greater weight. Similarly, if the store is going through a high-profit period, other factors such as efficiency or satisfying consumer satisfaction may be given greater weight.

One of ordinary skill will appreciate that objectives or factors may be selected by a user or by an algorithm. For example, the retail goals/objectives or the factors and their weights may be selected by tradeoff analytics engine, such as the IBM Tradeoff Analytics powered by the proprietary Watson platform. The Tradeoff Analytics employ a mathematical filtering technique called Paerto Optimization, which considers tradeoffs and considers multiple criteria for a single decision. One of ordinary skill will recognize that other algorithms may be used to select objectives, select factors, or assign weights.

According to an embodiment, since the identity of the consumer and the associated consumer profile may be considered a factor, system 100 may identify each consumer, or may identify a subset of consumers. Identifying consumers may be achieved, for example, via facial recognition, or by tracking an identifier that the consumer is carrying, such as a smartphone preprogrammed with a particular application, or an RFID card which could be read by a sensor. A combination of identifiers may also be used. For example, a consumer may swipe or otherwise register an ID card when they enter the store and then a facial recognition algorithm may process the consumer's face and then track the customer through the store.

The system may utilize the database 122 to store or analyze the objectives, factors, and/or weights. For example, each consumer may have an associated consumer profile. This profile may be stored the database 122 or it may be stored locally on the consumer's smartphone and communicated to system 100 when the consumer enters the store. Among other pieces of information, the things that may be stored within a consumer's user' profile include but is not limited to patronage history, including: (i) historic profitability; (ii) item purchase frequency; (iii) types of items purchased; (iv) profitability per visit; (v) duration of patronage; (vi) frequency of store visits; and (vii) purchase history, among others. The consumer's user profile may include user preference information, including when the consumer may desire human assistance, and/or whether the consumer robotic or human staff attention.

According to an embodiment, the system may utilize the database 122 to store information about the retail environment. For example, the database may store information including but not limited to item weight, item cost, item profit margin, item type, item location, and much more.

At optional step 250 of the method, the resources of the retail environment are analyzed. For example, the system may determine the location, status, or other information about the human and/or non-human resources within the retail environment. For example, the system may query the human and/or non-human resources within the retail environment to determine their location or last known location. The system may review sensor data to determine the location of the human and/or non-human resources within the retail environment.

At step 260 of the method, one or more of the human and/or non-human resources are managed based on the assigned priority of the resource event and the available resources within the retail environment. For example, once of the priority or weight of a resource event is determined, system 100 can determine which resource action, if any, taken by the system would further one or more retail goals of the system. This potential action can be weighed against the available resources and priority of other pending resource events. For example, at any given time, multiple resource events may be occurring for multiple consumers. Each resource event may be assigned a priority according to the method described above. Store resources may be allocated to resource events according to the respective priority of each, with higher priority resource events receiving store resources ahead of resource events with lower weights.

According to an embodiment, the human and/or non-human resources are assigned according to information about the availability of these resources within the retail environment. For example, system 100 may store in database 122 information about available resources, or about resources in general from which information about availability could be extracted or otherwise determined. For example, system 100 may comprise information indicating that the retail environment includes five total checkouts, four of which are currently staffed, each having long lines. If a consumer approaches the checkout area, system 100 may identify a resource event—a consumer's need to checkout—and prioritize the resource event according to the objectives of the store, such as efficient operation. Depending on the other resource events occurring at the same time, and the availability of additional staff, system 100 may elect to open a fifth checkout line to efficiently resolve the resource event. If, however, each staff member is preoccupied by an initiated and unresolved resource event, or all staff members are attending to higher prioritized resource events—such as helping high-profitability consumers—system 100 may not open the fifth checkout line, but instead keep the store resources according to their previous assignments.

According to an embodiment, the management of store resources may be further carried out by an algorithm or engine such as IBM's Tradeoff Analytics as described previously, which may be utilized to analyze store resources and priorities of resource events in view of retail environment objectives to intelligently manage the resources.

Managing the retail environment resources may involve affirmatively assigning or allocating robotic staff to attend to or resolve each resource event. Alternatively, or in combination, system 100 may assign human resources to attend to particular resource events. System 100 may assign human resources by directing them to particular resource event in the store, or by suggesting a resource event that needs attention. Assigning or suggesting a resource event to a human resource may be accomplished by sending a message to the human resource on a mobile device carried by each staff member, or it may push notifications to a screen that is viewable by staff members or by a manager who may then assign the resource event to a human staff member. Managing store resources may also be accomplished by activating self-help checkouts, kiosks, or touch screen aids throughout the retail environment, among many other methods.

According to another embodiment, the system 100 generates one or more resource recommendations that can be communicated to a user. The user can then decide whether to act on the recommendation, whether to authorize the system to implement the recommendation, or whether to ignore or decline the recommendation. Accordingly, at optional step 242 of the method, the processor generates a resource recommendation based at least in part on the priority assigned to the resource event in step 230 of the method. The resource recommendation may comprise, for example, a recommended allocation of a human resource and/or an automated resource within the retail environment.

At optional step 242 of the method, system 100 communicates the generated recommendation to a user of the system. For example, system 100 may comprise a monitor, screen, or other user interface that outputs continuous or periodic resource recommendations or other information about consumers, items, and the retail environment. Alternatively, the resource recommendation may be communicated to a user or another system using any communication method.

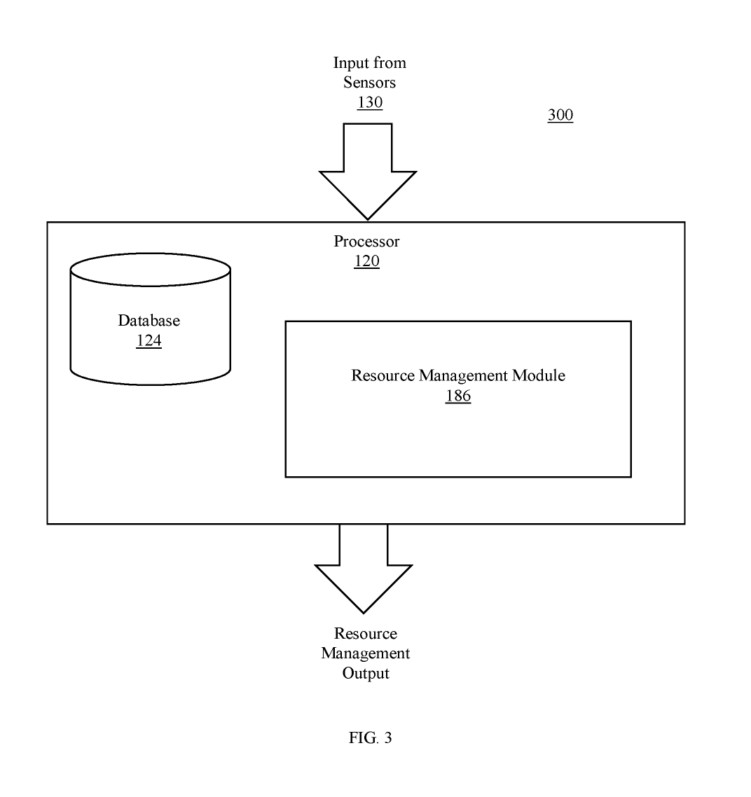

Referring to FIG. 3, in one embodiment, is a system 300 for allocating resources within a retail environment. According to an embodiment, system 300 can comprise any of the components described or otherwise envisioned herein, including but not limited to the data processing environment in the form of a computer or server, which can comprise a processor 120 configured to determine and analyze consumer needs within the retail environment in order to deploy human and/or automated resources in response to those needs. According to an embodiment, system 300 may comprise only a processor 120 configured with an algorithm to manage human and non-human resources within a retail environment.

According to an embodiment, processor 120 can comprise, in the form of a module and/or in the form of programming of processor 120, a resource manager module 124. Resource manager module 124 is configured to obtain information from the one or more sensors 130 of a retail environment 110. For example, the system can be continuously connected to the sensors, or can periodically query or receive data from the data source or sources. The sensor data received from the sensors can be utilized or processed or analyzed immediately, and/or can be stored for analysis at a later time or date. Accordingly, the computer or server can comprise a database 122 configured to store the information received from the one or more sensors, and/or any of the other information or items described or otherwise envisioned herein.

According to an embodiment, resource manager module 124 is configured or programmed to carry out one or more steps of the methods described or otherwise envisioned herein. For example, the resource manager module 124 can be configured to: (i) receive the sensor data from the one or more sensors 130 located at one or more locations within the retail environment; (ii) identify a resource event using the received sensor data; (iii) assign a priority to the resource event based on a predetermined weighting system, which may comprise one or more weighting factors; (iv) analyze the one or more human and/or non-human resources of the retail environment; and/or (v) manage the one or more human and/or non-human resources within the retail environment based on the assigned priority of the resource event and the available resources.

The present invention may be a system, a method, and/or a computer program product at any possible technical detail level of integration. The computer program product may include a computer readable storage medium (or media) having computer readable program instructions thereon for causing a processor to carry out aspects of the present invention. The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, configuration data for integrated circuitry, or either source code or object code written in any combination of one or more programming languages, including an object oriented programming language such as Smalltalk, C++, or the like, and procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the blocks may occur out of the order noted in the Figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

What is claimed is:

1. A method for managing resources in a retail environment, the method comprising:
receiving, from at least one of a plurality of sensors, sensor data representing information about at least one consumer in a retail environment, the plurality of sensors being part of a retail environment system comprising a processor and the plurality of sensors in communication with the processor, and the retail environment system further comprising at least one human resource and/or at least one automated resource, wherein the retail environment is associated with at least one retail objective;
identifying, by the processor using the received sensor data, a resource event comprising an event for which the at least one human resource or the at least one automated resource may be utilized;
assigning, by the processor, a priority to the identified resource event based at least in part on the at least one retail objective; and
managing at least one of the at least one human resource or the at least one automated resource based on the assigned priority.

2. The method of claim 1, wherein said resource event comprises a location of the at least one consumer.

3. The method of claim 1, wherein said resource event comprises an activity of the at least one consumer.

4. The method of claim 1, wherein said at least one retail objective comprises maximizing consumer satisfaction, maximizing profitability, and/or maximizing consumer spending.

5. The method of claim 1, wherein said priority is assigned based at least in part on a weighting system.

6. The method of claim 5, wherein said weighting system comprises a plurality of weighting factors.

7. The method of claim 6, wherein said weighting factors comprise historical information about the at least one consumer, at least one known preference of the consumer, an identity of a retail item within the retail environment being purchased by the consumer, or a profit margin of a retail item within the retail environment.

8. The method of claim 1, wherein said sensor data represents information about at least retail item within the retail environment.

9. The method of claim 1, wherein the at least one human resource comprises an employee of the retail environment.

10. The method of claim 1, wherein the at least one automated resource comprises a machine within the retail environment.

11. The method of claim 1, further comprising:
analyzing a status of the at least one human resource and the at least one automated resource within the retail environment, and further wherein said managing is also based at least in part on the analyzed status.

12. A system configured to manage resources in a retail environment, the system comprising:
a retail environment comprising a plurality of sensors, and at least one human resource and/or at least one automated resource, wherein the retail environment is associated with at least one retail objective; and
a processor configured to: (i) receive, from at least one of the plurality of sensors, sensor data representing information about at least one consumer in the retail environment; (ii) identify, by the processor using the received sensor data, a resource event comprising an event for which the at least one human resource or the at least one automated resource may be utilized; (iii) assign, by the processor, a priority to the identified resource event based at least in part on the at least one retail objective; and (iv) manage at least one of the at least one human resource or the at least one automated resource based on the assigned priority.

13. The computer system of claim 12, wherein said resource event comprises a location of the at least one consumer or an activity of the at least one consumer.

14. The computer system of claim 12, wherein said priority is assigned based at least in part on a weighting system comprising a plurality of weighting factors.

15. The computer system of claim 14, wherein said weighting factors comprise historical information about the at least one consumer, at least one known preference of the consumer, an identity of a retail item within the retail environment being purchased by the consumer, or a profit margin of a retail item within the retail environment.

16. The computer system of claim 12, wherein the processor is further configured to analyze a status of the at least one human resource and the at least one automated resource within the retail environment, and further wherein said managing is also based at least in part on the analyzed status.

17. A computer program product for managing resources in a retail environment, the computer program product comprising a computer readable storage medium having program instructions embodied therewith, wherein the computer readable storage medium is not a transitory signal per se, the program instructions readable by a computer to cause the computer to perform a method comprising:
receiving, from at least one of a plurality of sensors within the retail environment, sensor data representing information about at least one consumer in the retail environment;
identifying, by a processor using the received sensor data, a resource event comprising an event for which at least one human resource or at least one automated resource within the retail environment may be utilized;
assigning, by the processor, a priority to the identified resource event based at least in part on at least one retail objective associated with the retail environment; and
managing at least one of the at least one human resource or the at least one automated resource based on the assigned priority.

18. The computer program product of claim 17, wherein said resource event comprises a location of the at least one consumer or an activity of the at least one consumer.

19. The computer program product of claim 17, wherein said priority is assigned based at least in part on a weighting system comprising a plurality of weighting factors.

20. The computer program product of claim 17, wherein the method further comprises the step of analyzing a status of the at least one human resource and the at least one automated resource within the retail environment, and further wherein said managing step is also based at least in part on the analyzed status.

21. A method for managing resources in a retail environment, the method:
receiving, from at least one of a plurality of sensors within the retail environment, sensor data representing information about at least one consumer in the retail environment;
identifying, by a processor using the received sensor data, a resource event comprising an event for which at least one human resource or at least one automated resource within the retail environment may be utilized;
assigning, by the processor, a priority to the identified resource event based at least in part on achieving at least one retail objective of the retail environment, wherein said priority is assigned using a weighting system comprising a plurality of weighting factors; and
managing at least one of the at least one human resource or the at least one automated resource based on the assigned priority.

22. The method of claim 21, wherein the at least one human resource comprises an employee of the retail environment, and further wherein the at least one automated resource comprises a machine within the retail environment.

23. The method of claim 21, wherein said weighting factors comprise historical information about the at least one consumer, at least one known preference of the consumer, an identity of a retail item within the retail environment being purchased by the consumer, or a profit margin of a retail item within the retail environment.

24. A method for managing resources in a retail environment, the method comprising:
receiving, from at least one of a plurality of sensors within the retail environment, sensor data representing information about at least one consumer in the retail environment;
identifying, by a processor using the received sensor data, a resource event comprising an event for which at least one human resource or at least one automated resource within the retail environment may be utilized;
assigning, by the processor, a priority to the identified resource event based at least in part on achieving at least one retail objective of the retail environment, wherein said priority is assigned using a weighting system comprising a plurality of weighting factors;
generating, by the processor based at least in part on the assigned priority, a resource recommendation comprising a recommended allocation of at least one of the at least one human resource or the at least one automated resource; and
communicating the generated recommendation to a user.

25. The method of claim 24, further comprising the step of analyzing a status of the at least one human resource and the at least one automated resource within the retail environment, and further wherein said managing step is also based at least in part on the analyzed status.
